(19) United States
(12) Patent Application Publication
(10) Pub. No.: US 2007/0193758 A1
(43) Pub. Date: Aug. 23, 2007

(54) Air driver device

(76) Inventor: Koji Tatsuno, Osaka (JP)

Correspondence Address: WENDEROTH, LIND & PONACK, L.L.P., 2033 K STREET N. W., SUITE 800, WASHINGTON, DC, 20006-1021, US

(21) Appl. No.: 11/698,949

(22) Filed: Jan. 29, 2007

(30) Foreign Application Priority Data
Feb. 17, 2006 (JP) 2006-40775

(51) Int. Cl. B25D 15/00

(52) U.S. Cl. 173/176; 173/178; 173/93.5

(57) ABSTRACT

Provide an air driver device which is simple in construction and easily realizable in compact size, and has excellent durability. In an air driver device designed to shut off the supply of compressed air to the air motor 3, by means of a tightening torque control mechanism 6 and a shut-off valve mechanism 7, in case the tightening torque reached the set torque value, and tighten screw members at prescribed tightening force, the tightening torque control mechanism 6 is composed of a clutch unit 61, a driving piston 62 on the back face of which is formed one clutch plate 61a so that the clutch plates 61a, 61b of the clutch unit 61 may move by making rotational differential motions relatively in case the tightening torque reached the set torque value, a cylinder 63 for storing this driving piston 62, a check valve 64 for operating the shut-off valve mechanism 7, in linkage with the driving piston 62 through an oil charged in the cylinder 63, and a torque control member 65 for regulating the set torque value.

### BACKGROUND OF THE INVENTION

The present invention concerns an air driver device used for tightening screw members such as screws, bolts & nuts, etc., more specifically an air driver device for tightening screw members at prescribed tightening force.

Conventionally, as air driver device used for tightening screw members such as screws, bolts & nuts, etc., an air driver device is proposed and put to practical use which is designed to tighten screw members at prescribed tightening force, by shutting off the supply of compressed air to the air motor, by means of a tightening torque control mechanism and a shut-off valve mechanism, in case the tightening torque reached the set torque value (refer to JP 58-34265 B, JP 2004-106146 A).

This air driver device comprises an operating shaft for turning an air motor by opening the shut-off valve of a shut-off valve mechanism disposed in the air supply channel by pushing in a spindle, and is designed in such a way as to connect a cam turned by the air motor with the spindle, by means of a torque control mechanism which makes a differential rotational motion relatively in case the tightening torque reached the set torque value, so as to stop the air motor by closing the shut-off valve of the shut-off valve mechanism by moving the push rod with a differential rotational motion of the torque control mechanism.

To be more concrete, as torque control mechanism, this air driver device is designed to put balls 126, fit and supported in ball fitting holes 121 drilled in the spindle 101, in contact with the respective ball supporting faces 120 of the cam 105, and slidably fit, on the outer circumference of the ball fitting & supporting portion of the spindle 101, a cam ring 123 tapered on the face to be in contact with the balls 126, in the axial direction, to transmit the rotational driving force from the cam 105 turning with the air motor 103, through the balls 126, to the spindle 101, as shown in FIG. 13˜FIG. 14. On the other hand, this air driver device adopts a construction in which, when the tightening torque reached the set torque value, the balls 126 are pushed out in the direction of outer circumference from the ball supporting faces 120 of the cam 105, to stop the transmission of torque between the cam 105 and the spindle 101. In the case where the balls 126 are pushed up in the direction of outer circumference from the ball supporting faces 120 of the cam 105, a differential motion in the direction of rotation is produced between the cam 105 and the spindle 101, producing a difference of rotation between the two. This causes a pilot pin 122, provided in a way to turn together with the cam 105, to turn relatively against the spindle 101, to push up a lock pin 140 with the projected side of its chamfered step portion 131, release the engagement between the pilot pin 122 and the chamfered step portion 131 by the lock pin 140 and enable movement of the pilot pin 122 and the push rod 104, so as to stop the air motor by closing the shut-off valve 110 of the shut-off valve mechanism.

As explained above, the above-mentioned conventional air driver device, which uses, as torque control mechanism, a mechanism of complicated structure composed of constituent members such as a cam 105, balls 126, a cam ring 123, etc., is difficult to realize in compact size, and also presented a problem that the constituent members are easily worn and lack durability.

### SUMMARY OF THE INVENTION

In view of the problems of the above-described conventional air driver device, the objective of the present invention is to provide an air driver device of simple construction easily realizable in compact size and with excellent durability.

To achieve said objective, air driver device according to the present invention is an air driver device comprising an air driver, and designed to shut off the supply of compressed air to the air motor, by means of a tightening torque control mechanism and a shut-off valve mechanism, in case the tightening torque reached the set torque value, and tighten screw members at prescribed tightening force,

characterized in that the tightening torque control mechanism is composed of:

a clutch unit,

a driving piston on the back face of which is formed one clutch plate so that the clutch plates of said clutch unit may move by making rotational differential motions relatively in case the tightening torque reached the set torque value,

a cylinder for storing the driving piston,

a check valve for operating said shut-off valve mechanism, in linkage with said driving piston through an oil charged in the cylinder, and

a torque control member for regulating the set torque value.

In this case, it is possible to dispose, on said check valve, an inertial force absorbing piston movably in the axial direction of the check valve, so that the urging force of the spring constituting the torque control member may act, through the inertial force absorbing piston, on the check valve, and enable to temporarily store the oil in the auxiliary cylinder storing the inertial force absorbing piston.

According to the air driver device of the present invention, by constructing the tightening torque control mechanism with a clutch unit, a driving piston on the back face of which is formed one of clutch plates so that the clutch plates of said clutch unit may move by making relative rotational differential motions in case the tightening torque reached the set torque value, a cylinder for storing the driving piston, a check valve for operating said shut-off valve mechanism, in linkage with said driving piston through an oil charged in the cylinder, and a torque control member for regulating the set torque value, it becomes possible to realize a device of simple structure in compact size, and to provide an air driver device with excellent durability, having only a small number of easily worn constituent members, by interposing an oil charged in the cylinder in the working mechanism.

Furthermore, by disposing, on said check valve, an inertial force absorbing piston movably in the axial direction of the check valve, so that the urging force of the spring constituting the torque control member may act, through the inertial force absorbing piston, on the check valve, and enable to temporarily store an oil in the auxiliary cylinder storing the inertial force absorbing piston, it becomes possible to perform engagement and disengagement of the clutch unit smoothly, and prevent any excessive tightening of the screw members due to the inertial force produced at the time of working of the shut-off valve mechanism, thus enabling to perform accurate tightening with prescribed tightening force.

### BRIEF DESCRIPTION OF THE DRAWINGS

FIG. 1 is a front elevation showing an embodiment of the air driver device according to the present invention.

FIG. 2 is a sectional view of above.

FIG. 3 is a partial expanded sectional view of above.

FIG. 4 is a partial expanded sectional view of above.

FIG. 5 (a) is a plan view of the spindle, FIG. 5 (b) is a front elevation, and FIG. 5 (c) is a right side view.

FIG. 6 (a) is a plan view of the driving piston, FIG. 6 (b) is a front elevation, FIG. 6 (c) is a left side view, and FIG. 6 (d) is a right side view.

FIG. 7 (a) is a plan view of the cylinder, FIG. 7 (b) is a front sectional view, FIG. 7 (c) is a left side view, and FIG. 7 (d) is a right side view.

FIG. 8 is an explanatory drawing of the constituent members.

FIG. 9 (a) is a front sectional view of the grip, FIG. 9 (b) is a left side view, and FIG. 9 (c) is a right side view.

FIG. 10 is a sectional view before starting of the air driver device.

FIG. 11 is a sectional view during tightening of the air driver device.

FIG. 12 is a sectional view during a shut-off of the air driver device.

FIG. 13 (a) is a sectional view before starting of a conventional air driver device, and FIG. 13 (b) is a sectional view during a shut-off.

FIG. 14 (a1) and FIG. 14 (a2) are cross-sectional views of FIG. 13 (a), and FIG. 14 (b1) and FIG. 14 (b2) are cross-sectional views of FIG. 13 (b).

### DETAILED DESCRIPTION OF THE INVENTION

An embodiment of the air driver device according to the present invention will be explained below, with reference to drawings.

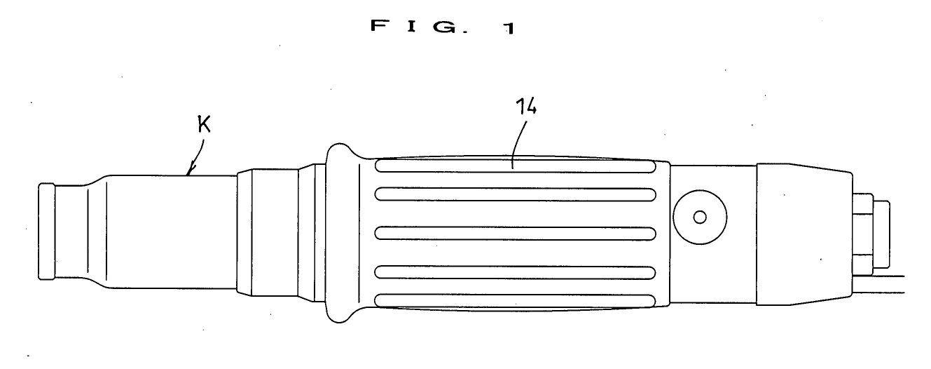

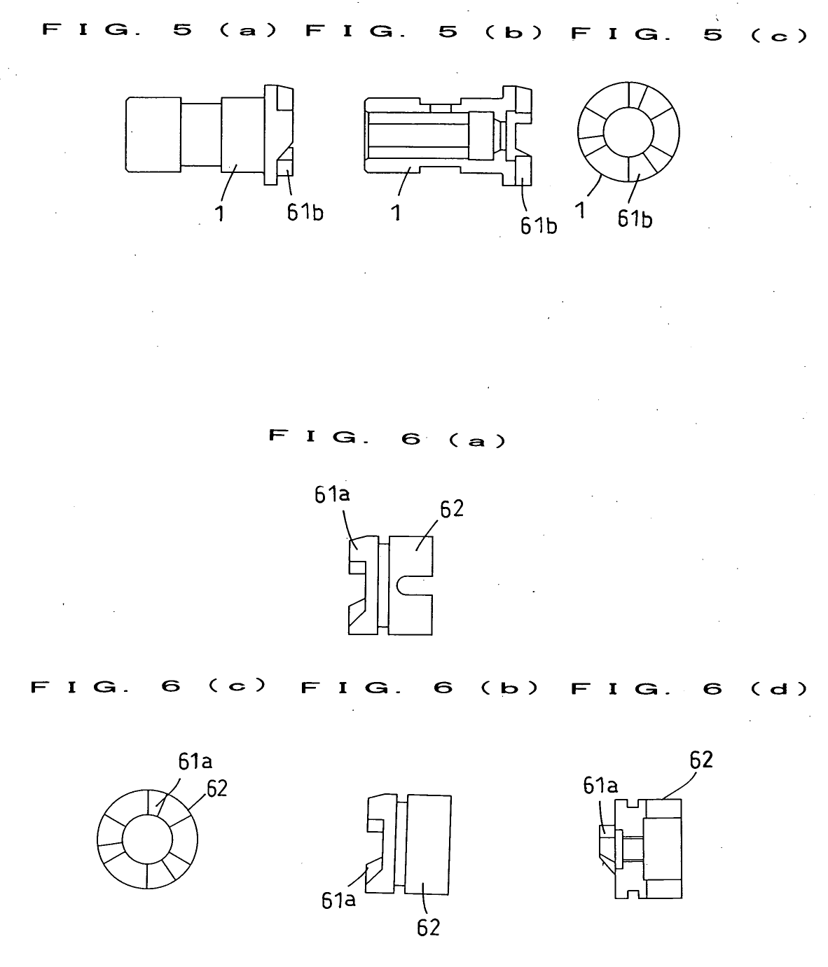

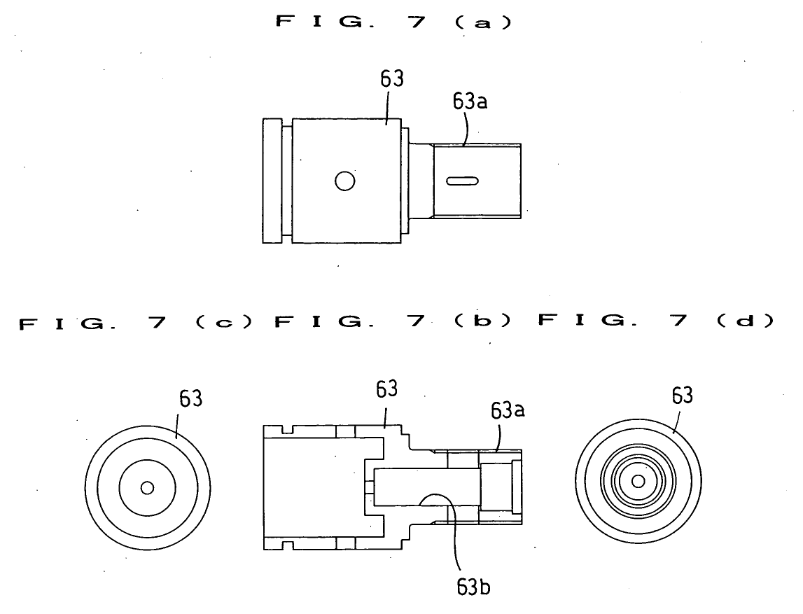

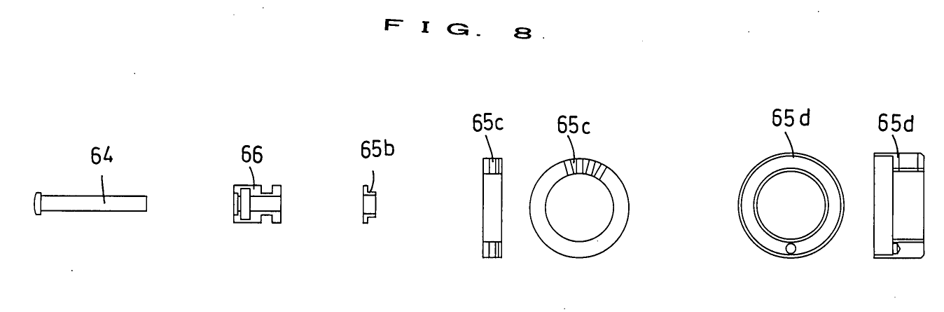

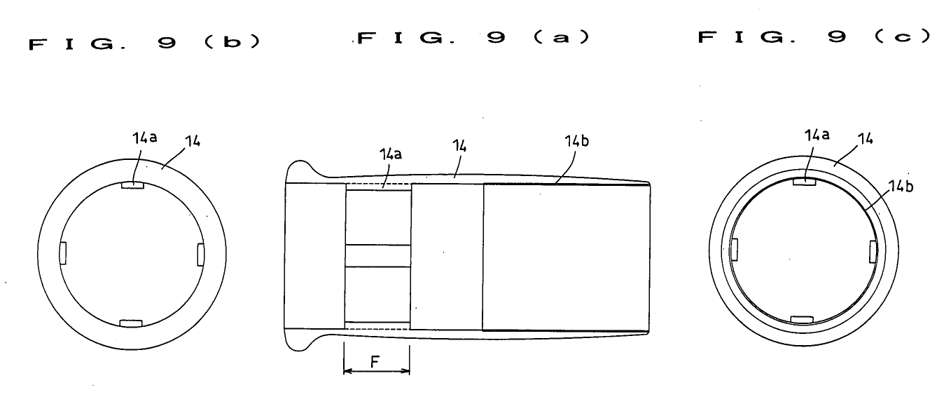

FIG. 1 to FIG. 12 indicate an embodiment of the air driver device according to the present invention.

This air driver device comprises a push rod 4 for turning an air motor 3 by opening a valve 2 disposed in an air supply channel 8 by pushing in a spindle 1, and is designed in such a way as to connect a speed-reducing drive unit 5 turned by the air motor 3 with the spindle 1, by means of a torque control mechanism 6, so as to shut off the supply of compressed air to the air motor 3, by means of the torque control mechanism 6 and a shut-off valve mechanism 7, and tighten screw members at prescribed tightening force, in case the tightening torque reached the set torque value.

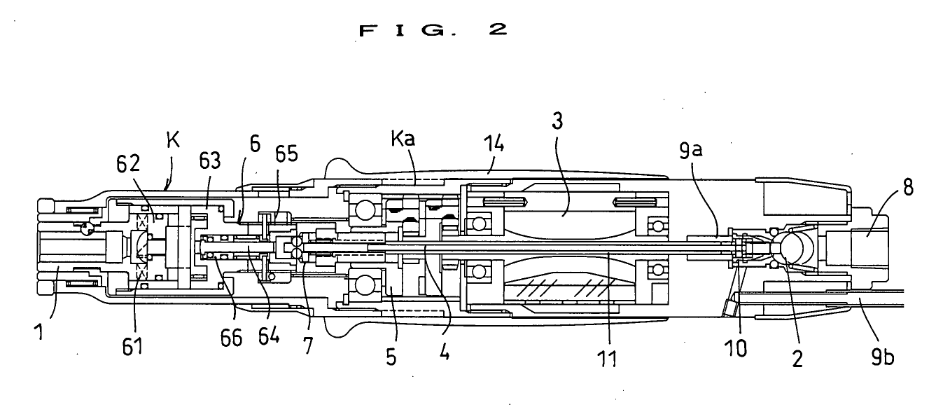

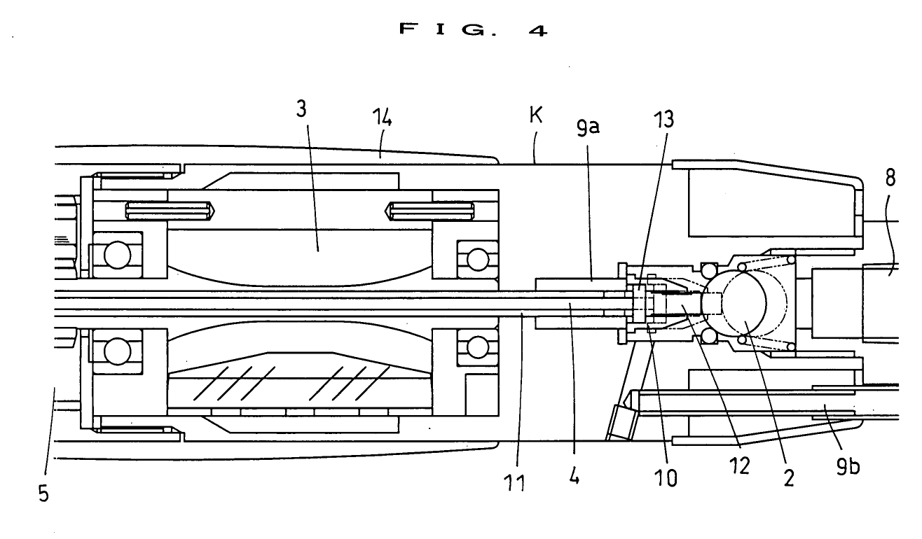

And, this air driver device is constructed by forming, on the downstream side of the valve 2 disposed in an air supply channel 8, an air motor side flow channel 9a communicating with the air motor 3, and a detecting side flow channel 9b communicating with a pressure detecting means (not illustrated), as shown in FIG. 2 and FIG. 4, in the same way as in the patent literature 2, disposing a plug 10 for closing only the air motor side flow channel 9a, by means of the torque control mechanism 6 and the shut-off valve mechanism 7, when the push rod 4 retreats, on the tip side of the push rod 4, and slidably placing a push pipe 11 on the push rod 4, so as to maintain the valve 2 in open state when pushing in the spindle 1 through the push pipe 11.

To be more concrete, the push rod 4 is slidably inserted in a slide bar 12 through which the plug 10 is slidably provided.

On the slide bar 12 is placed a push piece 13 for pressing the plug 10 from inside.

This enables the push rod 4 to keep the plug 10 in open state through the push piece 13.

On the other hand, the push pipe 11 is disposed in a way to get in contact with an edge of the slide bar 12, to open the valve 2 by moving the slide bar 12 with pressing of this edge part.

At that time, since the push piece 13 is placed on the slide bar 12, the push pipe 11 can open the valve 2 by putting the plug 10 in closed state without allowing the plug 10 to act on the push piece 13.

This makes it possible to apply a high-pressure air to the detecting side flow channel 9b, when stopping the air motor 3 by making the push rod 4 retreat, thus enabling to accurately count the number of times of tightening of bolts, etc. by recognizing (the number of times of) shut-off.

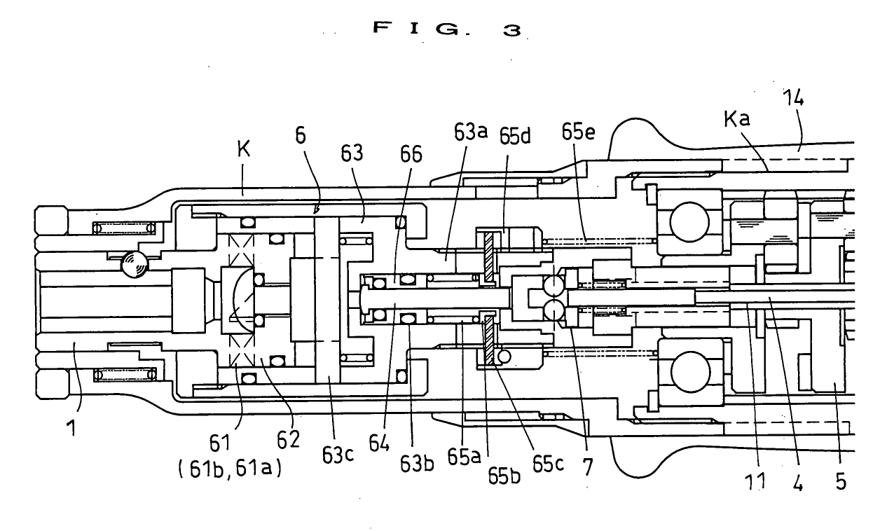

By the way, in this air driver device, the main part of the tightening torque control mechanism 6 is constituted, as shown in FIG. 2, FIG. 3 and FIG. 5 to FIG. 8, by a clutch unit 61, a driving piston 62 on the back face of which is formed a clutch plate 61a on one side so that the clutch plates 61a, 61b of the clutch unit 61 may move by making rotational differential motions relatively in case the tightening torque reached the set torque value, a cylinder 63 for storing this driving piston 62, a check valve 64 for operating the shut-off valve mechanism 7, in linkage with the driving piston 62 through an oil charged in the cylinder 63, and a torque control member 65 for regulating the set torque value.

In this case, the other clutch plate 61b of the clutch unit 61 is formed on the back face of the spindle 1.

Moreover, the torque control member 65 is composed of a torque adjusting spring 65a for urging the check valve 64, a spring support 65b, a detent 65c, a rotation adjusting member 65d and a locking spring 65e, making it possible to adjust the urging force of the torque adjusting spring 65a for urging the check valve 64, i.e. the set torque value, by operating the rotation adjusting member 65d, fastened to the male screw formed on the outer circumferential face of the storing unit 63a of the check valve 64 provided in extension in the rear part of the rotary cylinder 63, from outside through the air driver device body K.

And, on the check valve 64 is disposed an inertial force absorbing piston 66 slidably in the axial direction of the check valve 64, so that the urging force of the torque adjusting spring 65a may act through this inertial force absorbing piston 66 on the check valve 64, and that the oil of the cylinder 63 may be temporarily stored in the auxiliary cylinder 63b storing the inertial force absorbing piston 66.

This makes it possible to perform engagement and disengagement of the clutch unit 61 smoothly, and prevent any excessive tightening of the screw members due to the inertial force produced at the time of working of the shut-off valve mechanism 7, thus enabling to perform accurate tightening with prescribed tightening force.

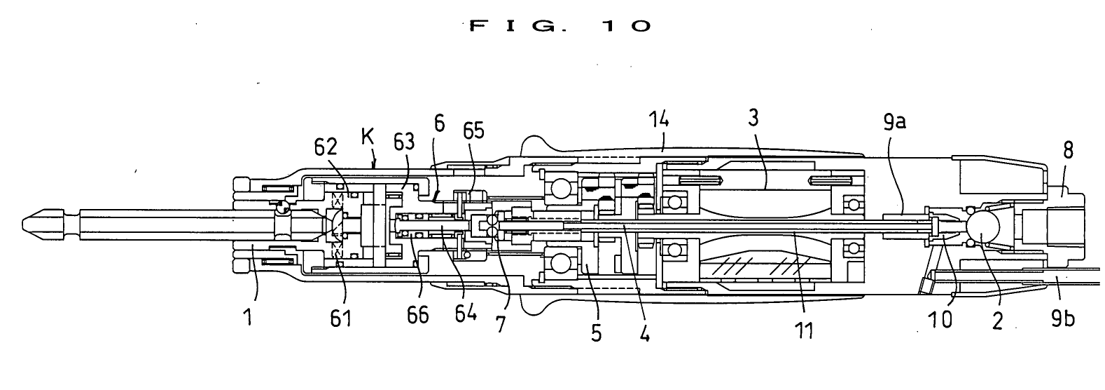

At the outer circumference of the air driver device body K is disposed, as shown in FIG. 1, FIG. 2 and FIG. 9, a grip 14 for absorbing reaction force in a way to cover the outer circumferential face of the air driver device body K.

This grip 14 is formed with a flexible material such as synthetic resin, rubber, etc., and the grip 14 and the air driver device body K are partially fixed at a part in the axial direction of the grip 14.

Here, the fixing of the grip 14 and the air driver device body K is made, though not particularly restricted, by fitting the fitting portion (fitting convexity) 14a formed on the inner circumferential face of the grip 14 to the fitting portion (fitting concavity) Ka formed on the inner circumferential face of the air driver device body K, for example, and by also fixing this part, as required, by using an adhesive, etc.

This makes it possible to absorb the reaction force transmitted from the fixing portion F of the grip 14 to the grip 14, as the non-fixed portion (right side of fixing portion F in FIG. 9 (a)) of the grip 14 is twisted, and to lessen the reaction force transmitted from the air driver device body K to the worker by three-dimensionally dispersing it.

The length of the fixing portion F of the grip 14 is set, though not particularly restricted, at 10 to 40%, preferably at 15 to 30% or so, of the overall length of the grip 14, depending on strength of fixing portion F of the grip 14, the magnitude of the supposed reaction force absorbed with twisting of the non-fixed portion of the grip 14, etc.

Furthermore, as material forming the grip body, soft gelatinous silicon resin or urethane resin may be used suitably.

This makes it possible to further mitigate the reaction force transmitted from the air driver device body K to the worker.

Still more, on the inner circumferential face of the non-fixed portion of the grip 14 may be disposed an isolating member 14b capable of mitigating the frictional resistance with the outer circumferential face of the air driver device body K.

In that case, the isolating member 14b shall preferably be disposed across the non-fixed portion of the grip 14 formed at about the same length as the length of the fixed portion F of the grip 14, against the fixed portion F of the grip 14.

This isolating member 14b may be made by suitably using a cylindrical body made of synthetic resin such as rigid polyolefinic resin, etc. or metal such as iron, aluminium, etc., rather than the material forming the grip body. The isolating member 14b may be integrally formed, as shape material, at the time of forming of the grip body.

This makes it possible to prevent the non-fixed portion of the grip 14 from being restrained to the outer circumferential face of the air driver device body K by a frictional resistance, and allow twisting of the non-fixed portion of the grip 14.

Next, explanation will be given on actions of this air driver device.

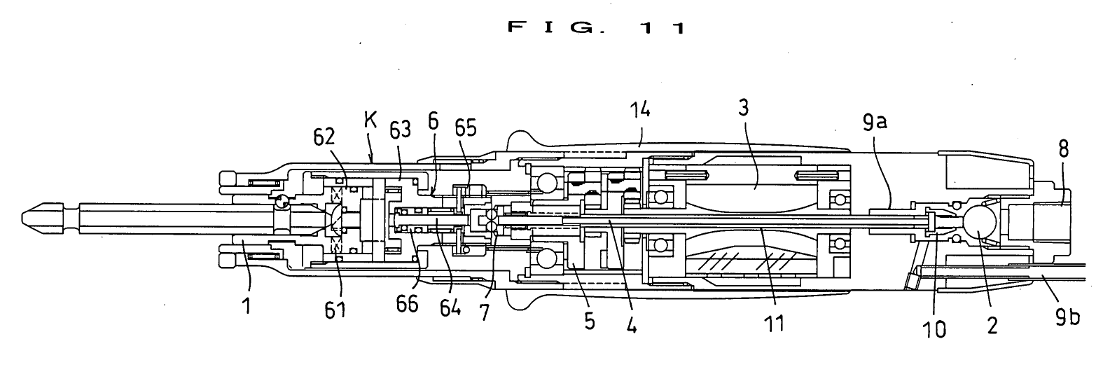

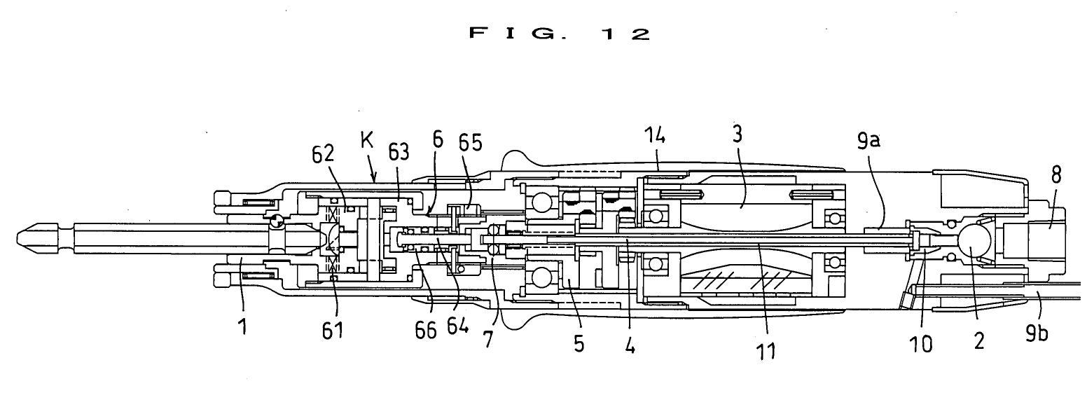

If, in the case of tightening of bolts & nuts or screws, etc., an attachment is loaded at the tip of the spindle 1, and the spindle 1 is pushed in the axial direction from the state of FIG. 10, operation is made in such a way that the valve 2 opens through the push rod 4, etc., as shown in FIG. 11, and high-pressure air is supplied from a compressor to the air motor 3. As a result, the air motor 3 turns in prescribed direction, and the tightening torque control mechanism 6 turns through the speed-reducing drive unit 5.

In the tightening torque control mechanism 6, the turning force is transmitted to the spindle 1, through the cylinder 63, the through shaft of cylinder 63c, the driving piston 62, and the clutch unit 61.

And, the spindle 1 retreats under a pressing force, during the tightening, to enable desired tightening.

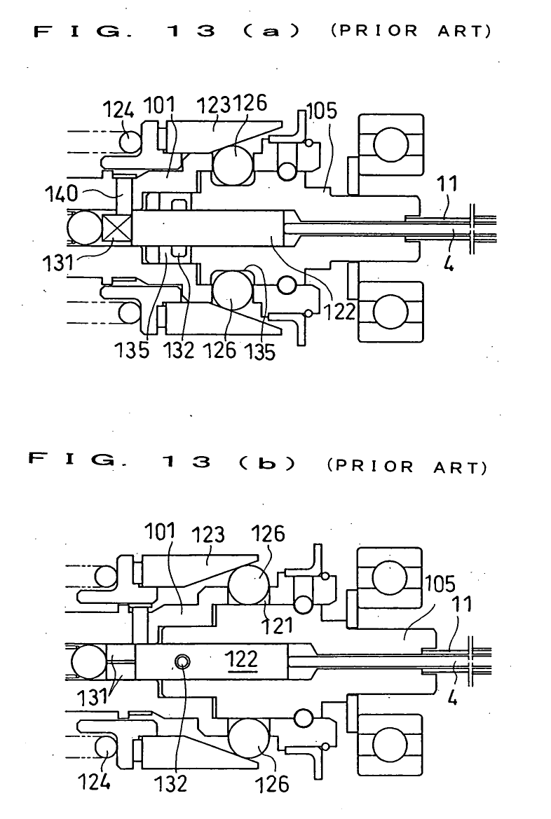

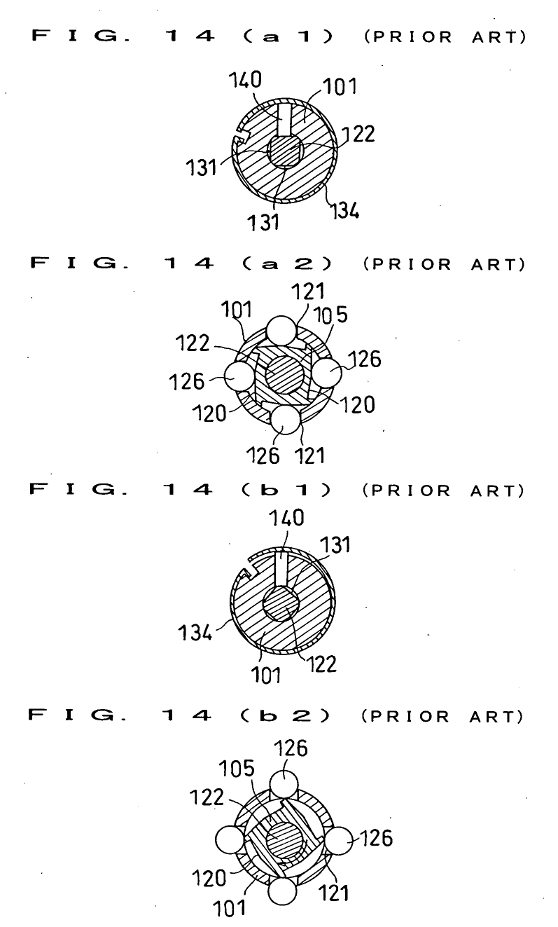

And, as the tightening progresses and the tightening torque reaches the prescribed tightening force which is the set torque value stipulated by adjusting the torque adjusting member 65 in advance, the clutch plates 61a, 61b of the clutch 61 make a differential rotational motion relatively, in resistance to the urging force of the torque adjusting spring 65a urging the check valve 64, as shown in FIG. 12, and the driving piston 62 moves in the axial direction, to thereby actuate the driving piston 64 through the oil charged in the cylinder 63, and operate the shut-off valve mechanism 7.

As a result, the push rod 4 retreats to close the plug 10, and stop the air motor 3.

At that time, because the push pipe 11 holds the valve 2 in open state, through the slide bar 12, with the subsequent pushing in of the spindle 1, it becomes possible to make the detecting side flow channel 9b act on the pressure detecting means (not illustrated) by supplying high-pressure air to it, thus enabling to count the number of times of tightening of bolts, etc. by recognizing the number of times of shut-off.

After the completion of tightening, a stop of pushing in causes the spindle 1, the push pipe 11, and the slide bar 12 to retreat (return to the tip side), closing the valve 2, and the torque control mechanism 6 and the shut-off valve mechanism 7 return to their initial positions, to get ready for the next tightening.

In addition, in this air driver device, the grip body of the grip 14 for absorbing reaction force disposed in a way to cover the outer circumferential face of the air driver device body K is formed with a flexible material, and the grip 14 and the air driver device body K are partially fixed at a part in the axial direction of the grip 14. This makes it possible to absorb the reaction force transmitted from the fixing portion F to the grip 14, with twisting of the non-fixed portion of the grip 14, thus enabling to lessen the reaction force transmitted from the air driver device body K to the worker.

So far, the air driver device according to the present invention has been explained based on an embodiment. However, the present invention is not restricted to the construction described in the above-mentioned embodiment, but may be changed in construction as required within the range not deviating from the purpose of the invention.

The air driver device according to the present invention, which is simple in construction and easily realizable in compact size, can be used suitably for an application of air driver device used in the assembling line of various types of electric machinery, etc.

1. An air driver device comprising an air driver, and designed to shut off the supply of compressed air to the air motor, by means of a tightening torque control mechanism and a shut-off valve mechanism, in case the tightening torque reached the set torque value, and tighten screw members at prescribed tightening force,
characterized in that the tightening torque control mechanism is composed of:
a clutch unit,
a driving piston on the back face of which is formed one clutch plate so that the clutch plates of said clutch unit may move by making rotational differential motions relatively in case the tightening torque reached the set torque value,
a cylinder for storing the driving piston,
a check valve for operating said shut-off valve mechanism, in linkage with said driving piston through an oil charged in the cylinder, and
a torque control member for regulating the set torque value.

2. An air driver device as defined in claim 1, on said check valve is disposed an inertial force absorbing piston movably in the axial direction of the check valve, so that the urging force of the spring constituting the torque control member may act, through the inertial force absorbing piston, on the check valve, and enable to temporarily store an oil in the auxiliary cylinder storing the inertial force absorbing piston.
